(19) United States
(12) Patent Application Publication
(10) Pub. No.: US 2008/0314715 A1
(43) Pub. Date: Dec. 25, 2008

(54) Security Element and Methods for Manufacturing and Authenticating the Same

(75) Inventors: Robertus Adrianus Maria Wolters, Eindhoven (NL); Mark Thomas Johnson, Eindhoven (NL); Pim Theo Tuyls, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 12/097,520

(22) PCT Filed: Nov. 29, 2006
(86) PCT No.: PCT/IB06/54501

§ 371 Date: Jun. 14, 2008

(30) Foreign Application Priority Data
Dec. 22, 2005 (EP) 05112753.8

(51) Int. Cl. G07D 7/00; G06K 19/067

(52) U.S. Cl. 194/302; 340/572.1

(57) ABSTRACT

A security element comprises at least one oscillating circuit (O1-On) and a digital signature (2). Each oscillating circuit (O1-On) comprises a capacitor (C1-Cn) as resonance frequency setting element wherein the capacitor (C1-Cn) consists of two electrodes (8, 10) which are spaced apart from each other and a dielectric (9) that is sandwiched between the two electrodes (8, 10). The capacitor (C1-Cn) of each oscillating circuit has a random capacitance value which randomness is caused by a non-uniform thickness (d) of the dielectric (9) and/or by an inhomogeneous dielectric material. The digital signature (2) comprises reference values indicative for the resonance frequencies (f1-fh) of the oscillating circuits wherein the reference values are digitally signed with a secret key.

The invention relates to a security element comprising at least one oscillating circuit.

The invention also relates to a system comprising a security element and a digital signature.

The invention further relates to a security control apparatus for reading out a security element

The invention further relates to an object provided with such a security element.

The invention further relates to a method for manufacturing a security element.

The invention also relates to a method of initializing the security element

The invention further relates to a method for authenticating an object provided with a security element comprising at least one oscillating circuit and a digital signature.

For the purpose of hindering counterfeiting of banknotes, passports and other security documents or objects, it is known to introduce security features. The tendency herein is towards electronic features that may be read out wirelessly. Such features provide an identification number that can be compared with a corresponding number in a central or local database. Requirements for such security features are:

Difficult to copy

Sufficient different values available for mass-production

Low-cost

Suitable for the manufacture and assembly process of value paper and the like

Reliable, i.e. it must always provide the correct output for authentication.

The above mentioned requirement ‘difficult to copy’ may be elaborated as follows:

Wireless data transfer in an encrypted form

Limitation of detectability of the actual data in the security document

Use of several, specific features

Detection abilities on different levels; e.g. a central bank may detect more features in a banknote than a shop.

It has already been proposed to integrate LC-circuits in value paper. For instance, EP 1 363 233 A1 discloses a value document, like a banknote or a passport, containing oscillating LC circuits that can be activated by applying an electromagnetic field. The oscillating circuits may have different resonance frequencies. The resonance frequencies are preferably selected in dependence on additional information provided on or in the value document, wherein this additional information can be arranged in the value document in coded form or in plain text. The additional information is e.g. the value of a banknote printed thereupon. Instead of or additionally to selecting the resonance frequencies in dependence on the additional information the particular arrangement (size, mutual distance, etc.) of the oscillating circuits can also be defined in dependence on the additional information, so that said arrangement can be used for a visual validity check, provided the oscillating circuits are arranged in a visual manner. This document also discloses setting the resonance frequency of the oscillating circuit by appropriately defining its size.

The security features incorporated in a value document as disclosed in EP 1 363 233 A1 meet some of the requirements listed above. Particularly:

It uses low-cost LC-circuits

LC oscillating circuits resonate at a specific resonance frequency that can be reliably read out within some range of tolerance.

Suitable for the manufacture and assembly process of value paper and the like.

There is, however, still a number of apparent disadvantages for the use of LC-circuits as proposed in EP 1 363 233 A1:

LC-circuits are simple in structure and thus can be copied easily by counterfeiters

The number of different resonance frequencies is inherently limited, particularly in view that for authentication purposes one measures a frequency band instead of one single frequency.

Not all frequencies can be used due to the facts that many RF frequency bands are reserved for various wireless transmission applications and that there is a need to avoid interferences.

As will be clear to the skilled person, the limitation of the number of resonance frequencies and the non-availability of some of the resonance frequencies further reduces an effective use of the LC circuit as a security element which should be difficult to copy.

It is therefore an object of the invention to provide a security element of the type defined in the opening paragraph, an object provided with such a security element, a method for manufacturing a security element and a method for authenticating an object provided with a security element comprising at least one oscillating circuit and a digital signature, in which the disadvantages of prior art solutions explained above are avoided.

In order to achieve the object defined above, with a security element according to the invention characteristic features are provided so that a security element according to the invention can be characterized in the way defined below, that is:

A security element comprising at least one oscillating circuit, wherein each oscillating circuit comprises a capacitor as an element for setting the resonance frequency of the oscillating circuit, the capacitor comprising two electrodes which are spaced apart from each other and a dielectric arranged between the two electrodes, wherein the capacitor has a random capacitance value

The random capacitance value may be implemented, for instance, with a non-uniform thickness of the dielectric and/or by an inhomogeneous dielectric material. Preferably, the security element allows a reading of the capacitor at different frequencies

The oscillating circuit may be configured as an active oscillating circuit comprising active electronic elements, like transistors, being connected with said capacitor as an element for setting the resonance frequency of the oscillating circuit. However, in regard of easy and cost-effective manufacturing it is preferred to configure the at least one oscillating circuit is a passive oscillating circuit, wherein each oscillating circuit may comprise an inductor and a capacitor.

The advantages of such a security feature are the following:

Security level: the feature allows both optical and electrical detection. Optically detectable parts are for instance the size and shape of the individual capacitors and the distance between individual capacitors.

Difficulty of copying: since the capacitors are measured optically as well, it is not possible to replace a certain capacitors with another one of the same magnitude, but different physical size.

Sufficient values: the capacitors are designed so that the inherent inhomogeneity in the dielectric is not smoothed out in the capacitors, but on the contrary that such the resulting differences are made to be measurable.

Integration into assembly: the LC-structure may be provided on a separate polymer foil, alike to the integration of a security thread that is commonly used in value papers.

In order to achieve the goals defined above an object, like a banknote, a document, a passport or a value paper, is provided with a security element according to the invention.

In order to authenticate the security feature, and therewith the object provided with the security feature, the present invention also provides a system of the security feature and a reference value. This reference value is suitably a digital signature, but could also be a data set in a database. A digital signature is for instance obtained in that the security feature is read out and modified with a security function in software. Such security function is for instance a hash function or another protocol such as known in the field of cryptography. A specific example is the helper-data algorithm as discussed later. One major advantage of the digital signature is the option of storage on or in the same object that comprises the security element. This allows authenticating the security element without making a connection to any centrally available memory, and thus without the need for additional infrastructure. The digital signature is preferably stored in such a manner as to be wirelessly readable. Examples of such storage positions include for instance an optically readable bar code, a memory of an IC, as part of an RFID transponder and another set of LC structures.

In order to achieve the object defined above, a method for initializing a security element is provided comprising the steps of:

providing at least one oscillating circuit by manufacturing, for each oscillating circuit, the elements of the oscillating circuit including a capacitor as an element for setting the resonance frequency, wherein the capacitor comprises two electrodes which are spaced apart from each other and a dielectric sandwiched between the two electrodes, wherein the capacitor has a random capacitance value,

measuring the resonance frequencies of the oscillating circuits by energizing them with an AC electromagnetic signal the frequency of which is swept over a predetermined frequency range and determining at which frequency the oscillating circuits resonate, and

transforming the measured resonance frequencies into reference values that are indicative for the resonance frequencies of the oscillating circuits.

In one advantageous embodiment, the method comprises the further step of putting a digital signature on the reference values by signing them with a secret key, wherein the digital signature is developed into a readable form and/or is stored in a data base or in a memory, like an RFID tag or an oscillating circuit, wherein the memory is arrangeable at an object to be secured with the security element.

The oscillating circuits may be configured as active or passive oscillators. It should be mentioned that the principles of configuring oscillators as well as assembling the necessary elements are common knowledge to those skilled in the art. The present invention lies in the use of a capacitor with a random capacitance value.

In order to achieve the object defined above, with a method for authenticating an object provided with a security element according to the invention characteristic features are provided so that such a method can be characterized in the way defined below, that is:

A method for authenticating an object provided with a security element according to the invention, wherein the authenticating method comprises:

measuring the resonance frequencies of the oscillating circuits, preferably by energizing them with an AC electromagnetic signal the frequency of which is swept over a predetermined frequency range and determining at which frequency the oscillating circuit resonates,

transforming the measured resonance frequencies into authentication values that are indicative for the resonance frequencies of the oscillating circuits,

verifying the reference values,

comparing the authentication values with the reference values, wherein, if they are equal or are at least within a predefined proximity, the object is regarded as authentic. Advantageously, the reference values are verified in the digital signature.

According to a further aspect of the invention, a security control apparatus is provided comprising (i) a support for an object having the security element of the invention; (ii) means for providing a frequency sweep with an AC electromagnetic signal so as to bring the oscillator circuits of the security element into resonance, and (iv) means for determining the resonance frequencies of the oscillating circuits of the security elements.

Suitably, the apparatus further comprises means for transforming the determined resonance frequencies into authentication values. Such means may be incorporated in an integrated circuit as will be known to the person skilled in the art of detection and measurement of electronic signals. It may further contain the means for comparing the authentication values with stored reference values.

Advantageous, the apparatus further comprises means for wirelessly reading a digital signature from the object and to compare the authenticated values with the digital signature.

In a further advantageous embodiment, the control apparatus allows the transformation of the resonance frequencies into an encrypted value. The measurement of resonance frequencies can be carried out with a high precision. This could give rise to non-acceptance due to differences as a consequence of noise. This disturbing effect of noise appears however to be reduced if the measured data are afterwards treated with a security function.

The term ‘support’ should be understood in a broad sense and including a substrate or any other rigid support, clamping means, a roller or the like on which any object, such as a paper can be moved. Suitably, the support is designed such that it allows the positioning of the oscillator circuits near to the means for providing the frequency sweep and the means for determining the resonance frequency. This reduces noise and effectively allows to reduce the strength of the electromagnetic field needed for providing the frequency sweep.

The security control apparatus may be a separate apparatus defined to authenticate objects with the help of one or several security elements and security features present in the object. Such apparatus is suitable for use in banks, in governmental offices including for instances offices at the border. Alternatively, the security control apparatus may comprise means for fulfilling other functions. Examples are cash registers comprising the means of the apparatus of the invention, and even portable terminals such as mobile phones and personal digital assistants.

The characteristic features according to the invention provide the advantage that the oscillating circuits are very difficult to copy, since detecting the outer dimensions (area, shape) of the capacitors does not enable an attacker to calculate the capacitance values of the capacitors, due to the built-in irregularities, i.e. a non-uniform distance between the electrodes and/or an inhomogeneous dielectric material, which result in randomness of the capacitance values. Further, the electrical detection of the capacitance by sweeping the frequency of an applied AC electromagnetic signal is quite precise, leading to detection of narrow frequency bands, and thereby providing a number of different resonance frequencies that is sufficient for mass production. A sufficient high number of capacitance values is also guaranteed by designing the capacitors in such a manner that the inherent inhomogeneity in the dielectric is not smoothed out in the capacitors, but on the contrary, that such inhomogeneities resulting in non-uniform dielectric coefficients are promoted when mixing and applying the dielectric material. Another approach is to create a layer of dielectric having varying thickness across its area, or at least having uneven or rough interfaces to the electrodes of the capacitor. Since the capacitance C of a capacitor is calculated by the formula:

C=∈A/d

wherein:
∈ . . . dielectric coefficient
A . . . area of the electrodes
d . . . thickness of dielectric, i.e. distance of electrodes
   both varying the dielectric coefficient in a random manner and varying the thickness of the dielectric layer and hence the distance of the electrodes result in a random capacitance.

In order to manufacture low-cost LC-circuits it is preferred to arrange the inductor on the dielectric.

By providing the inductors of the oscillating circuits with random inductance values the difficulties for an attacker to exactly copy the oscillating circuits are further increased. Random inductance values may be obtained by for example surrounding the inductor windings with a material displaying a random magnetic permeability. Examples of such materials are magnetic composite materials comprising a non-magnetic matrix with a random distribution of magnetic particles, preferably soft-magnetic particles such as iron (Fe), ferrites or soft-magnetic alloys such as NiFe alloys like “permalloy”.

By arranging the oscillating circuits on a substrate, like a polymer foil, the oscillating circuits are protected against tearing and the security element can be distributed as individual device for later incorporation in documents, banknotes and other objects. For further protection, the oscillating circuits are preferably sandwiched between two substrates, for example foil substrates. Preferably, the thickness and mechanical properties of the two substrates are substantially the same. In this manner, the oscillating circuits are less prone to damage by bending of the substrates.

As has been explained above, the electrical detection of the capacitance by sweeping the frequency of an electromagnetic AC signal applied to the oscillating circuit is quite precise, leading to detection of narrow frequency bands. However, with a narrow frequency band detection, the risk of making mistakes increases. Additionally, the accuracy of every measuring method is limited by the quantization noise, which cannot be ignored in narrow band detection of frequencies. While, at a first glance, these inherent measuring errors seem to impair the usability of narrow band detection, they nevertheless offer the opportunity to further increase the security level of the present security elements. This is accomplished by applying a helper-data algorithm, wherein during manufacturing in a so called “enrollment phase” the resonance frequencies of all oscillating circuits are measured by sweeping the frequency of an AC electromagnetic signal applied to the oscillating circuits and detecting the frequencies at which the oscillating circuits begin to resonate, wherein measuring the resonance frequencies also comprises using a noise correction which yields said helper-data. These helper-data are preferably added to the digital signature and can be used in an authentication process to detect the correct resonance frequencies of the oscillating circuits.

In order to further improve the security level of the present security elements it is proposed in an embodiment of the present invention to determine also at least one dimensional property of the capacitors, like the size, shape, or distances between adjacent capacitors, and to add these dimensional properties to the digital signature. It should be mentioned that those dimensional properties can be signed, i.e. incorporated in the digital signature. This embodiment enables to carry out an enhanced authentication method wherein additionally to electrically detecting the resonance frequencies also predefined dimensional properties of the capacitors of the oscillating circuits are measured, preferably by optical measuring methods, and the measured dimensional properties are compared with the dimensional properties contained in the digital signature. Thus, even if an eavesdropper finds a way to measure the resonance frequencies of the oscillating circuits with sufficient accuracy, due to the randomness of the capacitances of the capacitors of the oscillating circuits he cannot copy the oscillating circuits, but has to create oscillating circuits himself, but then he faces the problem that he will not be able to make capacitors with the required dimensional properties.

The aspects defined above and further aspects of the invention are apparent from the exemplary embodiment to be described hereinafter and are explained with reference to this exemplary embodiment.

The invention will be described in more detail hereinafter with reference to an exemplary embodiment. However, the invention is not limited to this exemplary embodiment.

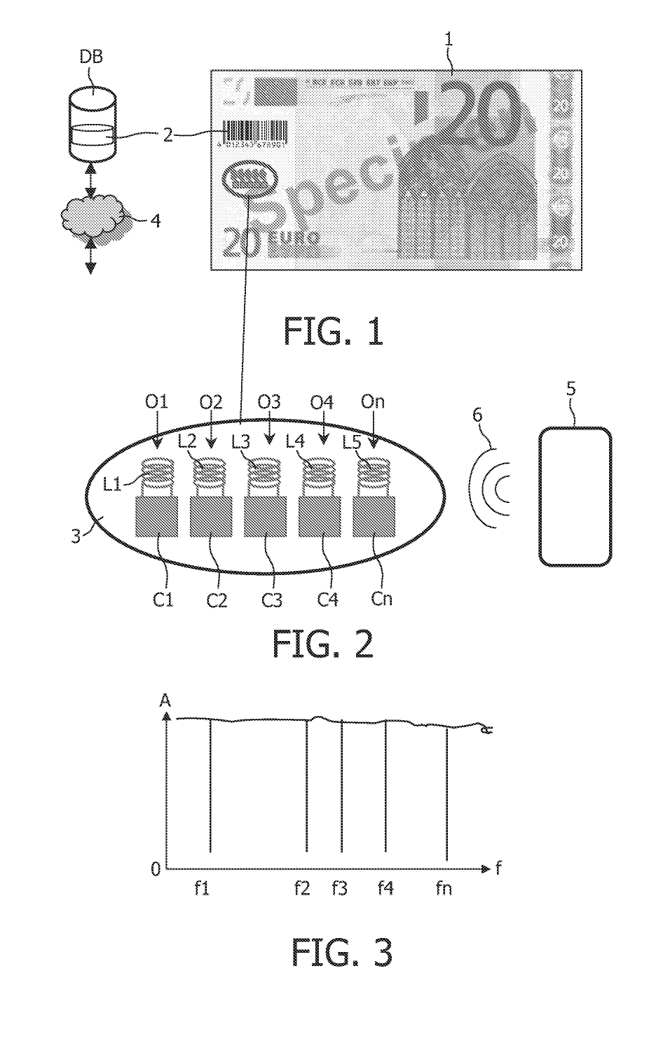

FIG. 1 shows schematically a banknote that is equipped with a security element according to the invention.

FIG. 2 shows schematically the oscillating circuits of the security element.

FIG. 3 is a chart that shows the resonance frequencies of the oscillating circuits.

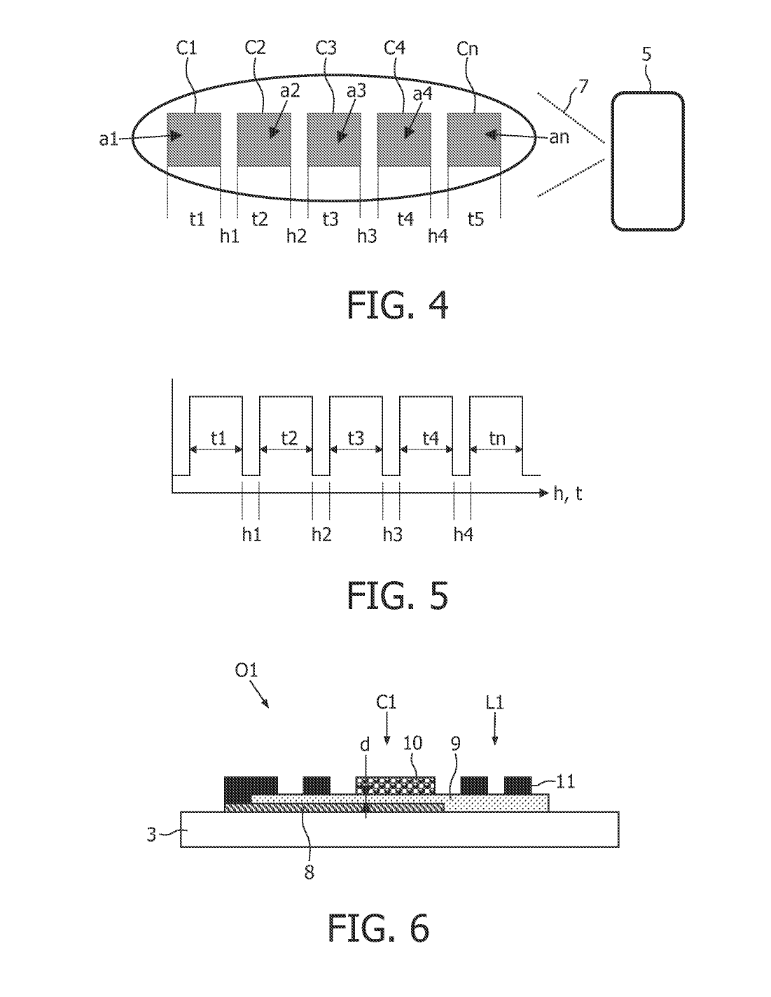

FIG. 4 is schematic top view of the capacitors of the oscillating circuits.

FIG. 5 is a diagram showing the distances between adjacent capacitors.

FIG. 6 is a cross section of a capacitor according to the invention.

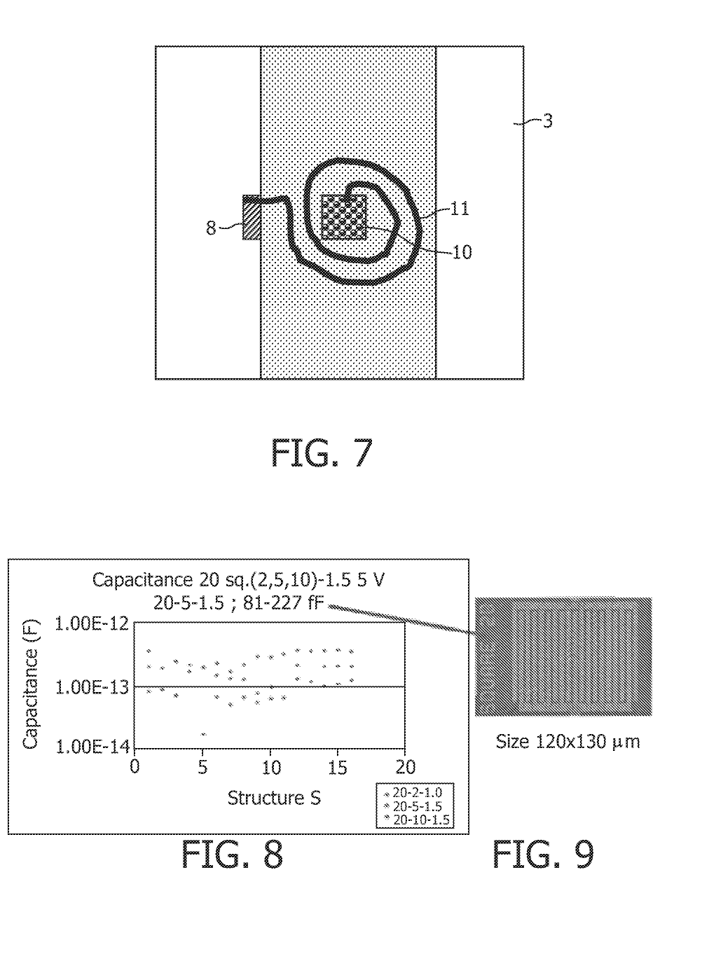

FIG. 7 is a top view of the capacitor of FIG. 6.

FIG. 8 is a chart showing the random capacitances of a capacitor structure depicted in FIG. 9.

FIG. 9 is a top view of a capacitor structure containing 16 capacitors in a comb arrangement.

FIG. 1 shows a banknote 1 as an example of an object to be secured with a security element according to the present invention. The security element comprises a plurality of oscillating circuits O1, O2, O3, O4, . . . On, that are formed on a common substrate 3, e.g. a security thread-like polymer foil 3 and a digital signature 2 that is printed on the banknote 1 and/or is stored in a database DB. The database DB can be a local database at a bank or shop or the like, or can be configured as a central database that is accessible by authorized users via a computer network 4, like the internet. Now also referring to FIG. 2 each oscillating circuit O1 to On comprises an inductor L1, L2, L3, L4, . . . Ln and a capacitor C1, C2, C3, C4, . . . Cn, wherein the terminals of the inductors are connected to the electrodes of the capacitors to form oscillating circuits. Each oscillating circuit O1, O2, O3, O4, . . . On has a resonance frequency f1, f2, f3, f4, . . . fn that can in theory be computed by the formula

fᵢ=1/(2π√LᵢCᵢ).

In order to apply this formula one has to know the exact values of the capacitance Cᵢ of the capacitors C1-Cn and of the inductance Lᵢ of the inductors L1-Ln.

However, according to the invention the values of the capacitance Cᵢ of the capacitors C1-Cn are random values, so in practice it is not possible for an attacker to use this formula for calculating the resonance frequency, since the result will always be a random value. The random capacities are achieved in this example by varying distances between the electrodes of the capacitors over their area and/or by an inhomogeneous dielectric material, as will be explained in detail below.

The preferred second component of the security element according to the present invention is the digital signature 2 that comprises reference values indicative for the resonance frequencies of the oscillating circuits wherein the reference values are digitally signed with a secret key.

After the oscillating circuits O1-On have been defined, in a subsequent enrollment or initialization step the resonance frequencies f1-fn of the oscillating circuits O1-On are measured by means of a wireless reader 5 that is adapted to energize the oscillating circuits with an AC electromagnetic signal 6, to sweep the frequency over a predetermined frequency range and to determine at which frequencies the oscillating circuits resonate. This frequency sweep mechanism is depicted in the diagram of FIG. 3, where the amplitude A of the electromagnetic signal 6 remains generally constant while the frequency of the electromagnetic signal 6 is swept over the predetermined frequency range. However, whenever the frequency f of the electromagnetic signal 6 corresponds to a resonance frequency f1, f2, . . . fn of one of the oscillating circuits a sharp notch appears in the curve that can be explained by the fact that an oscillating circuit in resonance represents a short circuit and therefore draws down the amplitude of the electromagnetic signal 6. Thus, by sweeping the frequency of the electromagnetic signal 6 the resonance frequencies f1-fn of all oscillating circuits O1-On can be determined with high resolution.

In order to get a better signal to noise ratio it is preferred to bring the reader 5 in a short distance of a few centimeters or less to the oscillating circuits.

After having determined the resonance frequencies f1-fn they are transformed into reference values b1, b2, . . . bn that are indicative for the resonance frequencies f1-fn of the oscillating circuits. For instance, transforming can be carried out by turning the resonance frequency values into bitstrings. In a next step, the reference values b1, b2, . . . bn are digitally signed by signing them with a private secret key. It is preferred to use asymmetrical cryptographic techniques for generating and verifying the digital signature, wherein a pair of keys consisting of a secret key for generating the digital signature and an associated public key for verifying the digital signature is applied. However, if secrecy of the secret key is guaranteed, a signing algorithm is acceptable wherein one secret key is used for both generating and verifying the digital signature.

It is further preferred to use oscillating circuits with high Q-factors leading to detection of narrow frequency bands. In order to achieve high Q-factors the resistances with the oscillation circuits have to be kept low. However, with a narrow band detection, the risk of making errors increases and the inherent noise, particularly the quantization noise, makes the measurement prone to errors. Hence, it is advisable to apply a noise correction algorithm during resonance frequency detection. For instance, for a given quantization step size q during enrollment a resonance frequency fi is measured and the noise correction algorithm will find appropriate helper-data wi such that the value of fi+wi is pushed to a nearest lattice point where fi+wi+δ will be quantized to the same value for any small δ. The values of helper-data wi, in the present embodiment the helper-data w1, w2, . . . wn that are assigned to the resonance frequencies f1-fn, are released by adding them to the digital signature 2. The helper-data can later be used in an authentication process to determine the correct resonance frequencies, as will be explained below. It should be mentioned that it may happen that additional helper-data on the derived bit strings have to be added too.

In a preferred embodiment of the invention, the reader 5 also comprises optical measurement equipment that optically scans (represented by numeral 7) the capacitors C1-Cn of the oscillating circuits and determines at least one dimensional property of the capacitors, like the widths t1-tn or the areas a1-an of the capacitors or the distances h1-h4 between adjacent capacitors (see FIGS. 4 and 5). The distances h1-h4 between adjacent capacitors are usually in the order of microns. The measured dimensional properties like the widths t1-tn or the areas a1-an or the distances h1-h4 can be signed, i.e. incorporated in the digital signature 2.

It should be observed that the helper-data w1-wn and the dimensional properties t1-tn, a1-an, h1-h4 can be added as plain text to the digital signature, or can be encrypted with the secret key and then be added to the digital signature.

The entire digital signature 2 is either developed into a man-readable or machine-readable form (for instance it is directly printed on an object provided with the security element or it is printed on a label that can be affixed to the object to be secured) or is stored in a data base DB, wherein the data base DB can be a central database that is accessible for authorized users via a computer network 4 or can be distributed to customers, in order to be used as a local database. Instead of printing the helper data and the digital signature on the banknote such that they have to be read out optically, in another embodiment of the invention they are stored in some form such that they can be read out with the electromagnetic field that is generated by the reader, too. Then the reader does not have to be able to read out things optically. This could e.g. be done by adding a very cheap RFID-tag into the banknote. The only data that the RFID-tag contains in its memory is the digital signature and the helper data. Alternatively the helper data and the digital signature could be stored in other oscillating circuits that have some fixed output, so that in fact they are only used as a kind of memory.

Next, with reference to FIGS. 6 and 7 the fabrication of the oscillation circuit O1 comprising a capacitor C1 with random capacitance and an inductor L1 is explained. On a substrate 3 that consists of a foil of polymer a bottom electrode 8 is applied, e.g. by a chemical or plasma deposition process. The bottom electrode 8 consists of a thin layer (e.g. 50 nm) of an electrically conductive material, e.g. Mo(Cr). In a next step a dielectric layer 9 is deposited onto the bottom electrode 8, e.g. by a spinning, printing or spraying process. According to the invention the dielectric layer 9 is made from an inhomogeneous dielectric material that consists of an electrically isolating matrix, e.g. an epoxy resin, like Novolac® which is a standard photo resist, or SU8, or PMMA, or the like, which matrix is filled with particles of different nature, e.g. particles of BaTiO₃, HfO₂, SiO₂, TiO₂, TiN, and the like. In contrast to known capacitor manufacturing processes, the inhomogeneities in the dielectric material are not smoothed out, thus resulting in capacitances with random values. Additionally, the thickness d of the dielectric layer 9 is varied over its area which also contributes to random capacities. After the dielectric layer 9 has been baked at e.g. 200° C. for a sufficient time to completely dry it a top electrode 10 is applied onto the dielectric layer 9. Preferably the top electrode 10 consists of Al, but plated Cu is an option, too. In a next step the inductor L1 is formed on the dielectric layer 9 by printing some windings 11 of a paste of electrically conductive material on the dielectric layer 9 and connecting the terminals of the windings 11 with the bottom electrode 8 and the top electrode 10, respectively. For protection and passivation purposes another foil (not shown in FIGS. 6 and 7) may be arranged over the oscillation circuit O1. Preferably, the thickness and mechanical properties of the two substrates are substantially the same. In this manner, the oscillating circuits are less prone to damage by bending of the substrates, as the stress levels at the plane where the circuits are situated are minimized by this configuration.

Typical capacitances of the capacitors are in a range between 1-50 pF for a square plate capacitor with lateral dimensions between 100 and 3000 μm. Typical values of induction of the inductors range between 25 nH and 250 nH. Combining said L and C ranges, the frequency range will be 50 MHz-1 GHz.

In FIG. 8 a chart of a typical result of the random capacitance values of 16 capacitor structures on a 2 mm substrate are shown. The capacitor structures are arranged in a comb structure that is shown in top view in FIG. 9. Each of the comb structures has a size of 0.12 mm*0.13 mm. The electrodes in the comb structures have fingered portions and are provided in an interdigitated pattern. The dielectric is here present between the electrodes of the comb structure and on top of the electrodes. The dielectric between the electrodes of the capacitors is an inhomogeneous dielectric material that consists of a matrix of epoxy resin filled with particles of TiO₂ and TiN, wherein the particle size of TiO₂ is 100-200 nm; the particle size of TiN is in the μm-range.

The design of the electrode structure turns out relevant to obtain the desired randomness. The comb structure was chosen as it allows to increase the exposed area of the electrodes and therewith the capacitance without an increase in size of the structure. Additionally, it allows that the dielectric between the fingered portions of the electrodes—interelectrode portion—and on top of the electrodes—overlying portion. The resulting inhomogeneity may be optimized due to the presence of two portions of dielectric, instead of merely one. Evidently, Other electrode structures providing dielectric with an interelectrode portion and an overlying or underlying portion may be chosen and optimized.

The distance between neighboring fingers of the electrode is chosen here to be 1.5 μm, which was found to work adequately. A suitable domain for the distance is in this example between approximately 0.8-3.0 μm, which corresponds to 5-20 times the average particle size. The inhomogeneity reduces below this value of 5 times the average particle size, as the contribution to the capacitance from the dielectric between the fingered electrodes diminishes—there are less particles in that portion of the dielectric and/or the portion is not filled with dielectric. The inhomogeneity also reduces above the value of 20 times the average particle size, due to leveling out.

The graph in FIG. 8 shows actually measurements for three different designs of security elements. The three designs differ with respect to the width of the fingered portions of the electrodes. This width was 2 microns in a first design, 5 microns in a second design and 10 microns in a third design. It turns out that the contribution of the overlying portion of the dielectric to the measured capacitance increases with increasing width of the fingered portion. Thus, the lowest point in the graph relates to the element with 2 micron width of the fingered portions, the middle point to the element with 5 micron width and the upper point to the element with 10 micron width. It further turns out that the resulting randomness decreases with an increasing contribution of the overlying portion. Although all may be used, the design with 5 micron width appears best. Herein, there is sufficient variation, while the measured capacitance values are still adequately measurable. Moreover, if converted to frequencies, this design is best as the resulting resonance frequencies will be present within a band that is not excessively broad. This would require a very big frequency sweep, and moreover increases the risk of undesired interactions with RF signals in use for wireless communication. The preferred range for the width would thus be between 1 and 10 times the distance between neighboring electrodes.

The capacitances of these capacitor structures vary randomly between 0.08-0.24 pF, for the design with 5 micron width. With a typical inductance of 50 nH, the resulting resonance frequencies vary between approximately 1.0 and 1.6 GHz. This allows for sufficient variation, if the resonance frequencies are measured with a precision of 10 MHz or more preferably with a precision in the range from 1 to 10 MHz. Even higher precision is not impossible with measurement equipment, but this requires an adequate limitation of noise. Moreover, a precision of 10 MHz and the use of 10 security elements provides already 1027 different codes. This may even be increased and improved with the use of further software algorithms.

It is observed that the specific structure of the security element may also be used for other objects than banknotes, passports, tickets and vouchers on security paper. For instance the structure could well be used within an integrated circuit. In that case, there is no need to use it within an oscillating circuit, but one may use it also independently.

In order to authenticate an object that has been provided with the security element according the invention, like the banknote 1 depicted in FIG. 1, the following authentication method has to be carried out:

A reader measures the resonance frequencies f′1, f′2, . . . f′n of the oscillating circuits O1-On, preferably by energizing them with an AC electromagnetic signal the frequency of which is swept over a predetermined frequency range and determining at which frequency the oscillating circuits resonate.

Next, the reader transforms the measured resonance frequencies f′1, f′2, . . . f′n into authentication values b′1, b′2, . . . b′n that are indicative for the resonance frequencies of the oscillating circuits.

Next, the reader reads the digital signature 2, either directly from the banknote 1 or from a database DB and verifies the digital signature 2 with an appropriate key that may either be a public key that matches with the secret key that has been used for generating the digital signature or the secret key itself. However, providing the possibility to use the secret key for verifying the digital signature makes high demands on keeping the secret key secret against all potential attackers. In practice these demands are hardly to meet and therefore is not advisable to use the secret key for verifying. Rather, it is preferred to use asymmetric pairs of secret keys and matching public keys. It should be mentioned that the helper-data are used at this point to take care of the noise.

Next, the reader compares the authentication values b′1, b′2, . . . b′n with the verified reference values b1, b2, . . . bn. If they are equal or in close proximity to each other, the banknote 1 is authentic, otherwise it is not.

In order to increase the available number of resonance frequencies and in order to achieve a higher security level it is preferred to define oscillating circuits with high Q-factors, in other words narrow frequency band oscillators. This in turn requires that when measuring the resonance frequencies noise has to be taken into consideration, which means that noise correction has to be carried out in order to find the correct values of the resonance frequencies. The preferred noise correction is based on helper-data w1, w2, . . . wn that are contained in the digital signature 2. An example of the use of helper-data has been explained above.

In order to further improve the security level of the present security element at least one dimensional property of the capacitors might have been measured during the enrollment phase and the values h1-h4 of the dimensional properties have been incorporated in the digital signature. In this case, during authentication the reader also has to measure said dimensional properties, preferably by optical equipment, and compares the measurement results h′1-h′4 with the values h1-h4 of the dimensional properties of the capacitors. If the values correspond, the banknote 1 is regarded as authentic.

In order to make a copy of the banknote, an attacker would have to copy the oscillating circuits and they have to correspond to the digital signature on the banknote. However, due to the randomness of the capacitances the attacker can not copy the oscillators in a banknote that he found. But he can of course make oscillating circuits himself. But then he cannot put the digital signatures on the outcome of the measurements as he does not have the secret key to generate digital signatures. In addition, if an optical scan approach is used, it will be difficult for the attacker to create the capacitors simultaneously with the correct dimensions and the correct value of capacitance.

1. A security element comprising at least one oscillating circuit that includes a capacitor for setting a frequency of the oscillating circuit, the capacitor comprising a first and a second electrodes which are spaced apart from each other, and a dielectric arranged between the electrodes, wherein the capacitor has a random capacitance value.

2. The security element as claimed in claim 1, wherein the at least one oscillating circuit (O1-On) is a passive oscillating circuit.

3. The security element as claimed in claim 1, wherein the randomness is caused by a non-uniform thickness (d) of the dielectric (9) and/or by an inhomogeneous dielectric material.

4. The security element as claimed in claim 1, wherein each oscillating circuit (O1-On) comprises an inductor (L1-Ln)

5. The security element as claimed in claim 3, wherein the dielectric material includes an electrically isolating matrix filled with particles of different nature.

6. The security element as claimed in claim 1, wherein the first and second electrode have an interdigitated structure.

7. The security element as claimed in claim 6, wherein the dielectric has an interelectrode portion between the first and second electrode and an overlying portion overlying or underlying the electrodes.

8. The security element as claimed in claim 4, wherein the inductor (L1) is arranged on the dielectric (9).

9. The security element as claimed in claim 1, wherein the oscillating circuits (O1-On) are provided on a substrate.

10. The security element as claimed in claim 9, wherein the oscillating circuits (O1-On) are sandwiched between two substrates.

11. The security element as claimed in claim 10, wherein the oscillating circuits (O1-On) are sandwiched between two substrates with substantially the same thickness and mechanical properties.

12. (canceled)

13. A system, comprising:
a security element that includes at least one oscillating circuit comprising a capacitor for setting a frequency of the oscillating circuit, the capacitor comprising a first and a second electrodes, spaced apart from each other, and a dielectric arranged between the electrodes, wherein the capacitor has a random capacitance value; and
a set of reference values corresponding to values of the security element, wherein the values of the security element are obtainable by determining the frequencies of the oscillator circuits and treating them with a security function.

14. The system as claimed in claim 13, wherein the reference values are present in the form of a digital signature, which is stored with the security element.

15. The system as claimed in claim 13, wherein the security function comprises helper-data allowing for noise-correction.

16. The system as claimed in claim 14, wherein the digital signature (2) comprises at least one dimensional property of the capacitors (C1-Cn).

17. The system as claimed in claim 14, wherein the digital signature (2) and optionally the helper-data and/or the dimensional properties of the capacitors are stored in a memory, wherein the memory is arrangeable to be secured with the security element

18. A method for initializing a security element, comprising:
providing the security element that includes at least one oscillating circuit comprising a capacitor for setting a frequency of the oscillating circuit, the capacitor comprising a first and a second electrodes, spaced apart from each other, and a dielectric arranged between the electrodes, wherein the capacitor has a random capacitance value,
and transforming the measured frequencies (f1-fn) into reference values (b1-bn) that are indicative for the frequencies of the oscillating circuits.

19. A method as claimed in claim 18, further comprising putting a digital signature (2) on the reference values (b1-bn) by signing the reference values with a secret key, wherein the digital signature is developed into a readable form and/or is stored in a data base (DB) or in a memory.

20. A method for authenticating an object provided with a security element, comprising:
measuring frequencies (f′1-f′n) of the oscillating circuits (O1-On) by energizing with an AC electromagnetic signal, the frequency being swept over a predetermined frequency range and determining at which frequency the oscillating circuit resonates,
transforming the measured frequencies (f′1-f′n) into authentication values (b′1-b′n) that are indicative for the frequencies of the oscillating circuits,
verifying the reference values (b1-bn),
comparing the authentication values (b′1-b′n) with the reference values (b1-bn).

21. The authentication method as claimed in claim 21, wherein the reference values are verified from a digital signature (2) that is either directly read from the object (1) or is read out from a data base (DB).

22. The authentication method as claimed in claim 20, wherein measuring the resonance frequencies (f′1-f′n) comprises carrying out noise correction by use of the helper-data that are extractable from the digital signature or that are printed on the document that is being protected.

23. (canceled)

24. (canceled)
